(19) United States
(12) Patent Application Publication
(10) Pub. No.: US 2022/0287288 A1
(43) Pub. Date: Sep. 15, 2022

(54) SUSPENSION ASSEMBLY FOR SPRAY BOOM OF AN AGRICULTURAL EQUIPMENT AND AGRICULTURAL WORK VEHICLE

(71) Applicant: CNH Industrial America LLC, New Holland, PA (US)

(72) Inventors: Paulo José de Andrade Alves, Piracicaba (BR); Thiago Kato Perez, Piracicaba (BR)

(21) Appl. No.: 17/690,439

(22) Filed: Mar. 9, 2022

(30) Foreign Application Priority Data
Mar. 12, 2021 (BR) 1020210047011

(51) Int. Cl. A01M 7/00

(52) U.S. Cl. CPC A01M 7/0053; A01M 7/0071

(57) ABSTRACT

A suspension assembly for the spray boom of work vehicles, such as sprayers, self-propelled or not, is formed by an upper shock absorber sub-assembly that comprises a first spring and a second spring responsible for connecting the support frame and the support, respectively in their side portions, being further formed by a lower shock absorber sub-assembly comprising a third spring and a fourth spring, which connect the lower portions of said support frame and said support.

### CROSS-REFERENCE TO RELATED APPLICATION

This application claims priority from and the benefit of Brazilian Application No. BR 10 2021 004701 1, entitled “Suspension Assembly for Spray Boom of an Agricultural Equipment and Agricultural Work Vehicle”, filed Mar. 12, 2021, which is hereby incorporated by reference in its entirety.

### FIELD OF THE INVENTION

The present invention relates generally to a new suspension assembly for spray boom of an agricultural equipment, such as those known as sprayers and applicators of agricultural substances in the field. Said suspension assembly being formed by technical, constructive and functional features that allow the reduction of the efforts applied in the assembly frame of the spray boom, but mainly, obtain a more balanced distribution of the forces generated by these spray boom.

Furthermore, the present invention also deals with an agricultural work vehicle intended for the application of products in the field, such as sprayers of agricultural substances, for example, fertilizers, pesticides, herbicides, etc., said work vehicle comprising an assembly suspension as indicated above.

### BACKGROUND OF THE INVENTION

Accordingly to the state of the art, various types of vehicles, equipment and agricultural machines are known developed to increase the productivity of cultivated fields, among which there are those work vehicles designed to dispense agricultural substances on the ground surface to be cultivated.

As it is well known, these work vehicles can include spray booms configured to facilitate the distribution of substances over a wide and extensive area of the field. Therefore, these spray boom are normally formed by a first and a second arms that extend from opposite sides of a support frame of the spray boom. Each of said first and second arms are usually movable in relation to the support frame between a folded and inoperative position and an extended and operative position and thereby allow the work vehicle to be adapted so that its dimensions, mainly the width, is reduced to provide better movement conditions when not spraying substances over the field.

As will be appreciated by those skilled in the art, during application of the agricultural substances in the field, one or both arms of the spray boom are placed in the operating extended position and configured to spray or otherwise dispense the agricultural substances over the field depending on the work vehicle travels across the ground. With the spray boom arms extended, each of the arms can oscillate and/or apply torque to the spray boom support frame due to the dimensions and weight of those arms. In order to provide a certain balance of loads in the frame, it is common to use suspension assemblies that seek to help compensate for the loads applied by the spray boom arms, these assemblies being formed by springs or hydraulic systems that, despite being highly efficient, naturally, end up revealing a more complex configuration and higher costs.

Particularly regarding to the suspension assemblies formed by springs known in the state of the art, it is noted that this type of solution reveals some inconveniences and practical limitations that interfere in the shock absorber efficiency and compensation of the loads and, therefore, present a load distribution in the unbalanced support frame, mainly when these vehicles are working on the edge of the fields, where often one of the spray boom arms is in the folded and inoperative position, which causes an overload on the side of the frame where the arm is in the extended and operating position, which can cause premature and unwanted wear on the spray boom frame and also on the work vehicle itself, considering that these loads only at one side of the support frame end up unbalancing the entire gravity center of the vehicle.

Thus, as it is possible to verify the suspension assemblies for agricultural sprayers known in the state of the art lack a practical and functional solution, but mainly simple and low cost, which is capable of providing a more balanced distribution of loads and efforts generated by the spray boom arms, mainly in situations where the vehicle is performing operations on the edges of the fields and, usually, in this situation they have a configuration where only one of the arms is in the extended and operating position.

Therefore, these are, in a way, some of the problems, inconveniences and solutions that it is intended to reduce, eliminate and provide with the development of the present invention.

### BRIEF DESCRIPTION OF THE INVENTION

Therefore, in view of the scenario mentioned above, the present invention aims to provide a new suspension assembly for spray boom of work vehicles, such as sprayers, self-propelled or not, which comprises constructive and functional technical features designed and developed to provide solutions to the problems, limitations and inconveniences generated by the state of the art, as summarized above and, in this way, obtain significant improvements in relation to the balance and distribution of loads applied to the support frame of the spray boom, mainly during operations of the edges of the cultivated fields that normally present a configuration where only one of the spray boom arms is in the extended and operating position, generating significant efforts on one side of the support frame.

Thus, in order to achieve the technical and functional effects summarized above, among others, the present invention refers to a suspension assembly for spray boom of work vehicles, mainly those intended for spraying and dispensing agricultural substances in the field, said suspension assembly being essentially formed by an upper shock absorber sub-assembly formed by a first spring and a second spring that connect the support frame and a support, respectively in their side portions, with the suspension assembly further comprises a lower shock absorber sub-assembly formed by a third spring and a fourth spring which connect the lower portions of said support frame and said support.

Accordingly to one embodiment of the suspension assembly of the present invention, said third and fourth springs are mounted in a central-side configuration, in which one of the ends of these springs are anchored in the lower side region of the support and the other end of these springs are anchored in the lower central region of the support frame.

Still, according to another embodiment of the present invention, said first spring of the upper shock absorber sub-assembly may be aligned with the third spring of the lower shock absorber sub-assembly. Alternatively, said second spring of the upper shock absorber sub-assembly may be aligned with the fourth spring of the lower shock absorber sub-assembly.

In accordance to a further possible embodiment of the present invention, said springs of the upper and lower shock absorber sub-assemblies comprise the same spring constant K. Alternatively, said springs of the upper and lower shock absorber sub-assemblies comprise different spring constant K.

In accordance to another particular embodiment of the present invention, said lower shock absorber sub-assembly may comprise shock absorbers positioned beside said third and fourth springs.

Optionally, according to a possible embodiment of the present invention, said springs are mounted on the respective suspension assemblies in the compressed condition.

As mentioned above, the present invention also refers to an agricultural work vehicle that is formed by a chassis supported by front and rear wheels, or optionally tracks assemblies, this chassis accommodates an engine and has an operator's cabin inside which control devices are arranged, the chassis supports a storage tank for agricultural substances, and this vehicle also comprises a spray boom mounted next to the chassis through a support and a support frame that has an assembly suspension as mentioned above.

In accordance to particular embodiments of the present invention, this agricultural work vehicle can be an agricultural equipment as a sprayer and applicator of agricultural substances in the field.

### BRIEF DESCRIPTION OF THE DRAWINGS

The features, advantages and technical effects of the present invention, as indicated above, will be more adequately understood by a person skilled in the art from the following detailed description, made by way of example only, and not restrictive of possible embodiments, and with reference to the attached schematic drawings, which:

FIG. 1 illustrates a perspective view of one embodiment of a work vehicle, such as an agricultural sprayer;

FIG. 2 illustrates a side view of a work vehicle, such as that illustrates in FIG. 1, in a configuration in which the spray boom arms are in the folded and inoperative position;

FIG. 3 illustrates a rear view of the spray boom of a work vehicle, as illustrates in FIGS. 1 and 2, and with the spray boom arms in the extended and operative position;

FIG. 4 illustrates a front view of the spray boom support frame with the suspension assembly, in accordance with the present invention;

FIG. 5A illustrates a rear view of the spray boom support frame with the suspension assembly, in accordance with the present invention, in a condition where both spray boom arms are in the same extended and operative or folded and inoperative position.

FIG. 5B illustrates a rear view of the spray boom support frame with the suspension assembly, in accordance with the present invention, in a condition where the second arm of the spray boom is in the extended and operative position, while the first spray boom arm is in the folded and inoperative position.

FIG. 5C illustrates a rear view of the spray boom support frame with the suspension assembly, in accordance with the present invention, in a condition where the first spray boom arm is in the extended and operative position, while the second spray boom arm is in the folded and inoperative position;

### DETAILED DESCRIPTION OF THE INVENTION

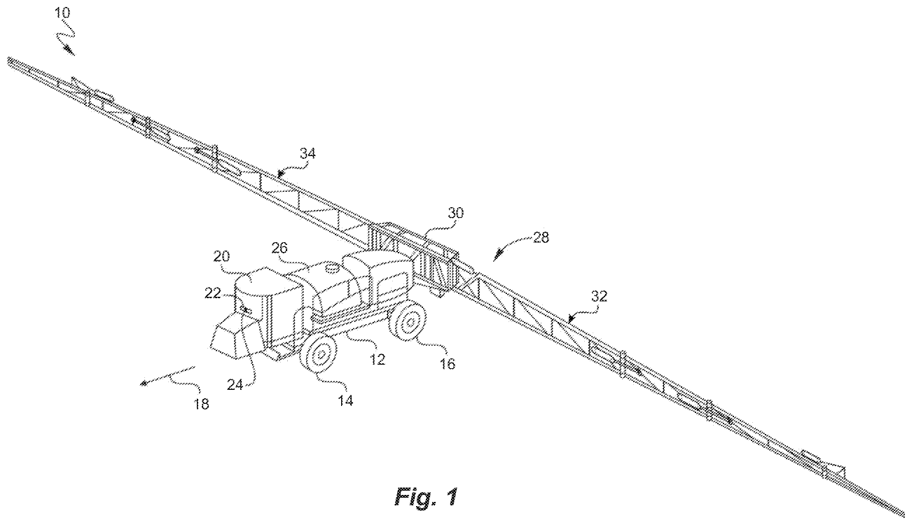

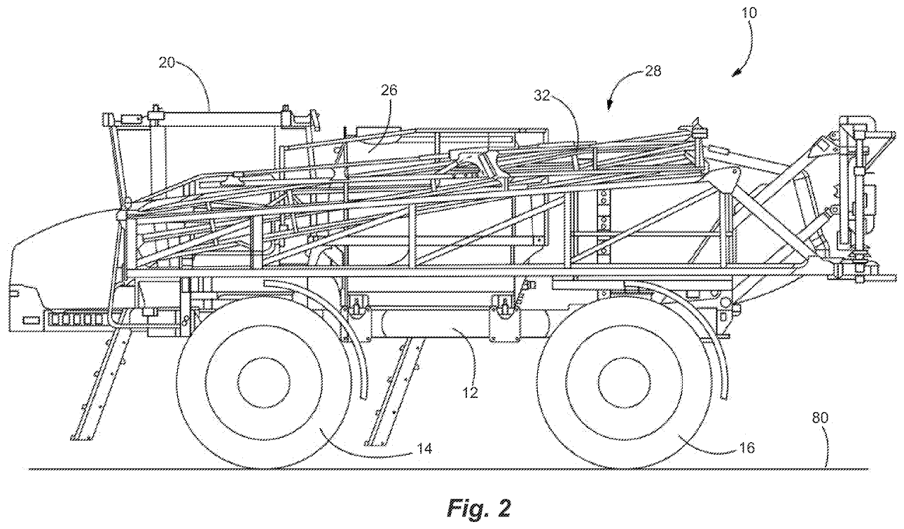

The invention will now be described with respect to its particular embodiments with reference to the attached drawings. Such drawings are schematic, and aim only to describe the invention in a didactic way. Furthermore, certain known and common constructive details may have been omitted for greater clarity and conciseness from the description that follows. The reference numbers used are repeated throughout the drawings to eventually identify identical or similar parts. The terms eventually used such as “above”, “below”, “front”, “back”, “right”, “left” etc., and its variants must be interpreted according to the indication given in FIGS. 1 and 2.

It is worth clarifying that the terms occasionally used herein as vehicle, machinery, agricultural equipment, dispensing machine, applicator and/or sprayer must be interpreted in an interchangeable manner to indicate any type of agricultural machine intended for the application of agricultural substances in the field. These vehicles and equipment can be, for example, of the self-propelled or towed type and, therefore, liable to be any model known in the state of the art, such as those manufactured and commercialized by CNH Industrial NV.

Thus, in order to better illustrate and facilitate the understanding of the present invention, the present invention is related to systems and mechanisms involving the shock absorber movement of the spray boom arms of a work vehicle. In this context, it is worth reiterating that among the various modalities, the spray boom includes a support configured to be coupled to the work vehicle. The first and second spray boom arms are mounted on opposite sides of a support frame. In addition, each of the first and second arms of the spray boom can be configured to move independently of each other between a folded inoperative position and an extended operative position so that the spray boom can arrange the first and the second arms in the folded position, the first and second arms in the extended position, the first arm in the extended position with the second arm in the folded position and/or the first arm in the folded position with the second arm in the extended position.

Still with the purpose of contextualizing the present invention, and with reference to FIGS. 1 and 2, it is possible to observe a work vehicle 10, such as a self-propelled spray equipment, which includes a chassis 12 configured to couple or support a series of devices, equipment and systems to facilitate the distribution of agricultural substances, such as fertilizers, pesticides, herbicides, etc., as work vehicle 10 travels across the field as indicated by arrow 18. Accordingly to the model represented in FIGS. 1 and 2, this work vehicle 10 may comprise front and rear wheels 14, 16 coupled to the chassis 12 which also accommodates an engine, such as a combustion, electric, hybrid or any other type of engine capable of generating enough energy for the vehicle operation 10.

Chassis 12 may also support an operator's cabin 20 within which various control devices (e.g. levers, pedals, control panels, buttons and/or the similar) are installed to allow an operator to monitor and control the operation of a work vehicle 10. For example, as illustrates in FIG. 1, the work vehicle 10 may include a human-machine interface 22 to display messages and/or alerts to the operator and/or to allow the operator to perform certain functions as a controller of the vehicle 10. In some embodiments, the interface 22 may include one or more user input devices 24 in the form of switches, buttons, and/or any other device and mechanisms for the operator to provide commands to be executed by the vehicle 10.

Furthermore, said chassis 12 may also comprise a tank 26 and a spray boom 28. This tank 26 is generally configured to store or hold an agricultural substance, such as a pesticide, a fungicide, a rodenticide, a fertilizer, a nutrient, and/or similar. The agricultural substance stored in the tank 26 can be distributed to the surface of the underlying ground (e.g. plants and/or ground) through one or more distributors (such as nozzles) mounted on the spray boom 28.

As illustrates in FIGS. 1 and 2, the spray boom 28 may include a support frame on which the first and second arms 32, 34 are mounted in a rocking condition. The first and second spray boom arms 32, 34 are generally movable between an operative or extended position (FIG. 1) and an inoperative or folded position (FIG. 2). During the process of distributing the agricultural substance over the field, the first and/or second spray arms 32, 34 extend laterally away from the work vehicle 10 to cover large strips of ground, as illustrates in FIG. 1. However, in order to facilitate the transport, each arm 32, 34 of the spray boom 28 can be folded, independently of one another, forwards or backwards into the inoperative position, thus reducing the overall width of the vehicle 10, or in some instances, the total width of a towable implement when the applicator is configured to be towed behind the work vehicle 10.

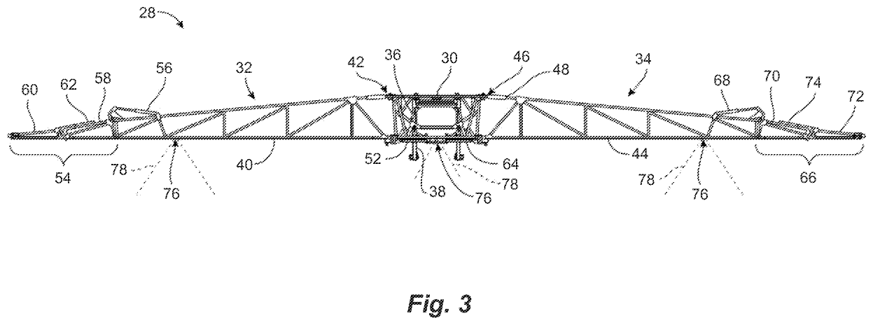

Referring now to FIG. 3, the spray boom 28 includes a support 36 coupled to the support frame 30. In some embodiments, as illustrated in FIG. 3, the support 36 is configured to be coupled to the work vehicle 10 via a linkage assembly 38. In this embodiment, the support frame 30 and the support 36 are aligned with each other along the direction of movement 18. As a result, the torque applied to the support 36 by the support frame 30 is substantially less than the torque applied by a support frame 30 positioned behind the support 36. Consequently, the support frame 30 and the support 36 can employ lighter structural members and/or fewer structural members to resist torque, thereby reducing the weight of the entire spray boom 28 frame. The reduced weight of the spray boom 28 decreases the load applied to the vehicle 10, thus reducing ground compaction and/or facilitating the use of smaller/less powerful vehicles. Due to the reduction in the costs of purchasing and operating smaller/less powerful vehicles, the general expenses associated with agricultural production can be reduced significantly.

Still referring to FIG. 3, the support frame 30 is configured to support the first and second spray arms 32, 34 during operation and transport. As illustrated, the first and second arms 32, 34 are coupled to and extend from opposite side portions of the support frame 30. In some examples, an internal section 40 of the first spray arm 32 is pivotally coupled to a first side portion 42 of the frame 30 and an internal section 44 of the second spray arm 34 is coupled to an opposite second side portion 46 of the frame 30. In this configuration, the first and second spray arms 32, 34 can be folded forward or backward from the illustrated operative position to an inoperative position which reduces the overall width of a work vehicle 10.

In some examples, as illustrates in FIG. 3, spray boom 28 includes a positioning assembly 48 operatively coupled to the support frame 30 and to the first and second spray arms 32, 34. Positioning assembly 48 may be configured to independently move each of the first and second arms 32, 34 between extended and folded positions. For example, in some embodiments, the first arm 32 includes an actuation device 52 (e.g., an electromechanical actuator, a hydraulic cylinder and/or a pneumatic cylinder) that extends between the internal section 40 of the first arm 32 and the support 30. In examples where actuation device 52 is configured as a hydraulic cylinder and/or pneumatic cylinder, actuation device 52 may be hydraulically coupled to a fluid supply source that supplies pressurized fluid to drive the piston rod to extend and retract the first spray arm 32. It must be appreciated by those skilled in the art that the fluid power supply may be hydraulic or pneumatic, thereby powering a corresponding hydraulic or pneumatic drive device 52. In the illustrated embodiment, extension of the piston rod drives the first spray arm 32 to the illustrated operative position and retraction of the piston rod drives the first spray arm 32 to the inoperative position. That is, retraction of the piston rod induces the first arm 32 to rotate forward around a pivot, thus reducing the overall width of the vehicle 10. In examples utilizing an electromechanical actuator, the actuation device may include a motor electrically coupled to a power source that is configured to rotate the first arm 32 between the extended, operative position and the folded, inoperative position.

The first spray arm 32 also includes an external part 54 having a peripheral actuation device 56. As illustrated, the external part 54 is coupled to the internal section 40 by a linkage gasket. As the actuation device 52, the peripheral actuation device 56 may be an electromechanical actuator, hydraulic cylinder and/or pneumatic cylinder. In the examples using a hydraulic and/or pneumatic cylinder, the cylinder may be configured to displace a piston rod extending from device 56. Retracting the piston rod of the device 56 will cause the external portion 54 to rotate upward from the product dispensing position as illustrated to an inoperative position. However, it will be appreciated that alternative embodiments may employ external portions configured to rotate forward or backward to the inoperative position.

In the illustrated embodiment, the external portion 54 includes an external section 58, a separable section 60, and a polarization member 62. The external section 58 extends between the internal section 40 and the separable section 60. Separable section 60 is pivotally coupled to external section 58 by a gasket and the polarization member 62 is configured to propel the separable section 60 toward the illustrated operative position. In this configuration, contact between the separable section 60 and an obstacle causes the separable section to rotate. After the spray arm has passed the obstacle, the polarization member 62 will propel the separable section back to the operating position.

The frame of the second spray arm 34 is similar to the frame of the first spray arm 32. For example, the second arm 34 includes an actuation device 64 (e.g. an electromechanical actuator, a hydraulic cylinder and/or a pneumatic cylinder) extending between the internal section 44 and the support frame 30. The device 64 may be electrically coupled to a power source and/or hydraulically coupled to a fluid power supply that supplies pressurized fluid to drive the piston rod to extend and retract the arm. It will be appreciated that the fluid power supply may be hydraulic or pneumatic, thus powering a corresponding hydraulic or pneumatic device 64. In the illustrated embodiment, extending the piston rod drives the second spray arm 34 into the illustrated operating position and retraction of the piston rod drives the second arm 34 into the inoperative position. That is, retraction of the piston rod causes the second spray arm 34 to rotate forward around a pivot, thus reducing the overall width of a work vehicle 10.

The second spray arm 34 also includes an external portion 66 having a peripheral actuation device 68. As illustrated, the external portion 66 is coupled to the internal section 44 by a linkage gasket. In the same manner of the device 64, peripheral actuation device 68 may be an electromechanical actuator, a hydraulic cylinder and/or a pneumatic cylinder configured to rotate the external portion 66 with respect to the internal section 44 by electromechanically rotating the external portion 66 and/or displacing a piston rod extending from peripheral actuation device 68. Retracting the piston rod of the peripheral actuation device 68 will cause the external portion 66 to rotate upward from the illustrated product dispensing position to an inoperative position. In some embodiments, the external portions are configured to rotate forward or backward to the inoperative position.

In the illustrated embodiment, the external portion 66 also includes an external section 70, a separable section 72, and a polarization member 74. The external section 70 extends between the internal section 44 and the separable section 72. The separable section 72 is pivotally coupled to the external section 70 by a gasket and the polarization member 74 is configured to urge the separable section 72 toward the illustrated operative position. In this configuration, a contact between the separable section 72 and an obstacle causes the separable section to rotate. After the spray arm passes through the obstacle, the polarization member 74 will propel the separable section back to the operating position.

Referring further to FIG. 3, it is noted that the work vehicle 10 may include one or more sensors 76 configured to capture data indicative of an orientation or position of the spray boom 28 relative to the ground surface 80. In some cases, sensor(s) 76 may be installed or otherwise positioned on spray boom 28. For example, as illustrates in FIG. 3, a sensor 76 can be positioned on each of the first and second spray arms 32, 34. As such, each sensor 76 can have a field of action directed towards a location below and/or in front of the spray boom 28 with respect to the direction of movement 18, as represented, according to some examples, by the dashed lines 78 in FIG. 3. Accordingly, each sensor 76 may be able to capture data indicative of the profile or contour of the ground surface 80 within its field of action 78. In a particular embodiment, the captured data may be indicative of a distance between the associated sensor 76 and the ground surface 80, this distance generally being associated with the distance between the respective spray arm 32, 34 and the ground surface 80. Based on the detected distance, various metrics can be determined, such as an oscillation frequency of the first or second arms 32, 34. In some examples, the sensor(s) 76 may be positioned at any other suitable location and/or coupled to any other suitable component of a work vehicle 10. In several examples, the work vehicle 10 may include any suitable number of sensors 76 and the number of sensors 76 and the number of sensors 76 represented in FIG. 3 must not be interpreted as a limiting aspect.

In several examples, the sensor(s) 76 may generally correspond to any suitable detection device(s) to identify data relating to position, angle, movement, distance, velocity, acceleration of any component of the spray boom 28. For example, in some embodiments, the sensor(s) 76 may be Light Detection and Ranging sensors (LIDAR) which are configured to output one or more output signals to reflect the ground surface 80 and receive or detect the return signal(s). Additionally, or alternatively, the sensor(s) 76 may correspond to radio detection and ranging sensor(s) and radio range (RADAR), Hall effect sensor(s), gyro sensor(s), magnetometer sensor(s), accelerometer sensor(s), yaw rate sensor(s), piezo sensor(s), position sensor(s), complementary metal-oxide-semiconductor sensor(s) (CMOS), pressure sensor(s), capacitive sensor(s), ultrasonic sensor(s), or any other suitable type of sensor known and available for the desired application.

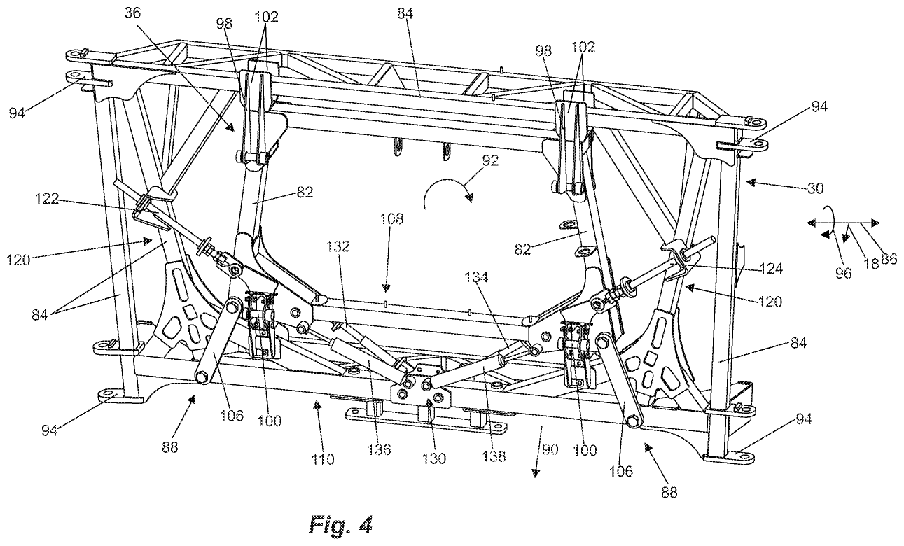

By way of example, and as better represented in FIG. 4, the support frame 30 is arranged around the support 36, and both are aligned with each other along the direction of movement 18. In this case, both the support 36 and the support frame 30 may be formed by several structural members 82, 84, which particularly reveal substantially rectangular cross-sections. These structural members 84 of the frame 30 are aligned with a first plane 86 substantially perpendicular to the direction of movement 18, and the structural members 82 of the support 36 are aligned with a second plane substantially perpendicular to the direction of movement 18. In the illustrated embodiment, the first and second planes are aligned with each other along the direction of movement 18, thus aligning the frame 30 and the support 36 in a rearward direction. Consequently, the overall length of the vehicle can be reduced compared to configurations where the frame 30 is positioned behind the support 36. Furthermore, due to the alignment of the support 36 and the frame 30, the radial load on the linkage assembly 38 and/or the vehicle chassis 12 can be significantly reduced. Therefore, the linkage assembly and/or vehicle chassis 12 may include lighter structural elements, thus reducing the overall weight of a work vehicle 10.

As illustrates in the attached drawings, the support frame 30 may be coupled to support 36 via links 88 configured to transfer downward load 90 from the frame 30 to the support 36. For example, the weight of the first and second spray arms 32, 34 is supported by the frame 30, and the frame 30 transfers the load to the support 36 via link 88. The support 36, in turn, transfers the load to the vehicle chassis 12 via linkage assembly 38, thereby suspending spray boom 28 above the ground surface 80.

In addition, links 88 facilitate rotation of frame 30 relative to the support 36 in a direction 92 (that is, around an axis parallel to the direction of movement 18). As a result, the spray boom can remain substantially parallel to the ground surface 80 despite the movement of the vehicle 10. For example, if the vehicle 10 leans to one side due to variations in terrain, the spray boom can pivot on the support 36 to remain substantially leveled with the ground surface 80. Consequently, a height of each applicator (e.g. spray nozzle) can be maintained at a desired distance above the ground surface 80.

Additionally, it can be noted that the support frame 30 may include several supports 94 configured for rotationally coupling the first and second spray arms 32, 34. For example, each support 94 may include openings configured to receive a pin coupled to a respective spray arm 32, 34. In this configuration, the supports 94 will support the downward load 90 of the first and second spray arms 32, 34, while facilitating rotation of the first and second arms 32, 34 between the operative position and the inoperative position. As previously discussed, the first and second arms 32, 34 are configured to pivot to the inoperative position. While in the inoperative position, the first and second arms 32, 34 can propel the frame 30 to rotate in a direction 96 around an axis 86 perpendicular to the direction of movement 18. Accordingly, the support 36 may include a number of guides configured to interface with frame 30 to block rotation of frame 30 relative to support 36 around an axis 86. For example, in some embodiments, the frame 30 may comprise upper guides 98 coupled to an upper portion of the frame 30 and lower guides 100 coupled to a lower portion of the frame 30. As illustrated, these guides 98 and 100 include coatings 102 configured to facilitate the movement of the frame 30 as it is rotated relative to support 36 in the direction 92. Therefore, guides 98 and 100 block rotation of the frame 30 in direction 96, while allowing the frame 30 to rotate in direction 92.

As previously discussed, the frame 30 is coupled to the support 36 via links 88 that is configured to transfer downward load 90 from the frame 30 to the support 36. The links 88 may comprise a plurality of links 106 that extend from a lower portion 108 of the support 36 to a lower portion 110 of the frame 30. These links 88 facilitate rotation of the frame 30 relative to the support 36 in direction 92. As a result, the spray boom can remain substantially parallel to the ground surface 80 despite the movement of the vehicle 10. Furthermore, a suspension assembly, as will be discussed below with reference to the present invention, is provided for associating the support frame 30 and the support 36, this assembly being configured to cushion mainly the rotational oscillations of said structure 30 in relation to the support 36, thus providing a more stable platform for the applicators and/or a more balanced distribution of the tension generated by the arms of the spray boom.

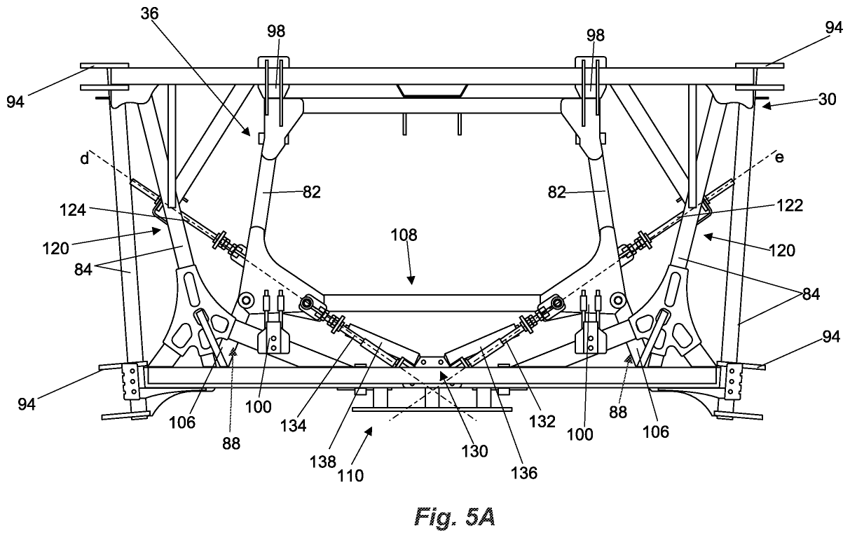

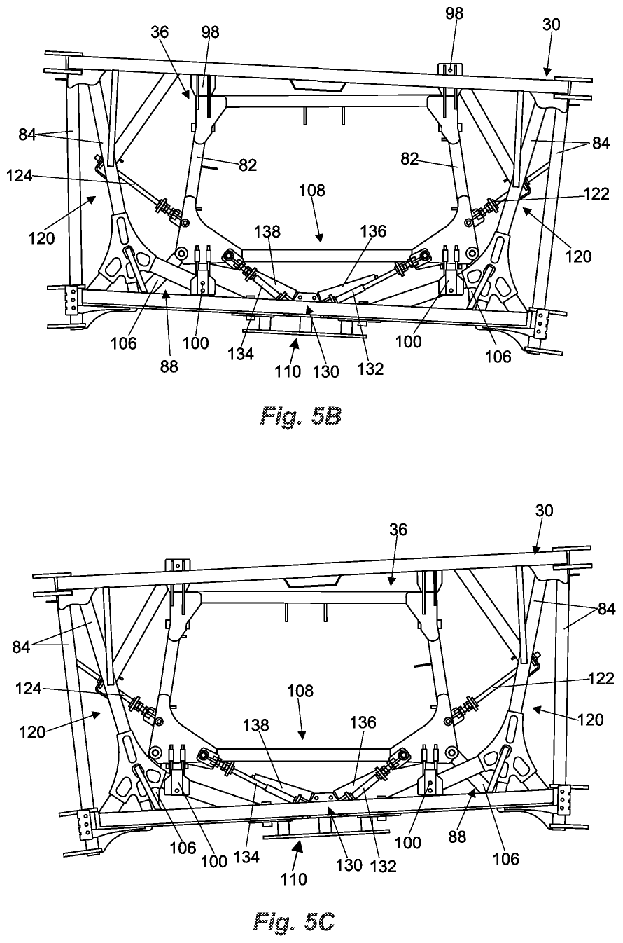

In view of the context presented above, and now with particular reference to FIGS. 4, 5A and 5B, the suspension assembly for the spray boom of an agricultural equipment, according to the present invention, comprises an upper shock absorber sub-assembly 120 formed by a first spring 122 and a second spring 124 connecting said support frame 30 and support 36, respectively, on their left and right sides. Additionally, in accordance with the present invention, said spray boom suspension assembly comprises a lower shock absorber sub-assembly 130 which is formed by a third spring 132 and a fourth spring 134 which connect the lower portions of said support frame 30 and the said support 36 in a side-central configuration, wherein one of the ends of said springs 132, 134 are anchored in the lower side region of the support 36 and the other end of said springs 132, 134 are anchored in the lower central region of the support frame 30.

More particularly, in accordance with one embodiment of the present invention, which is better illustrates in FIG. 5A, said first spring 122 of the upper shock absorber sub-assembly 120 is relatively aligned with third spring 132 of lower shock absorber sub-assembly 130, as illustrates by line (e), and said second spring 124 of upper shock absorber sub-assembly 120 is relatively aligned with fourth spring 134 of lower shock absorber sub-assembly 130, as illustrates by line (d).

Additionally, according to a particular embodiment of the present invention said springs 122, 124, 132, 134 of the upper and lower shock absorber sub-assemblies 120, 130 comprise the same spring constant K. Optionally, as will be appreciated by those skilled in the art, and depending on the project and design specifications, said springs 122, 124, 132, 134 may comprise different spring constants K and thereby provide an adjustment of the structural rigidity of the spray boom 28.

In yet another possible embodiment of the suspension assembly for the spray boom in accordance with the present invention, the lower shock absorber sub-assembly 130 may comprise shock absorbers 136, 138 positioned alongside the third and fourth springs 132, 134 to thereby provide auxiliary means that manage to improve the distribution and balance of the efforts generated by the spray arms 32, 34, mainly when only one of them is in the extended and operative position and, thereby, provide an element capable of improving energy dissipation.

Accordingly to a further possible embodiment of the present invention, said springs 122, 124, 132, 134 are mounted on the suspension assembly in the compressed condition, that is, in the natural and normal equilibrium condition of the support frame 30, said springs 122, 124, 132, 134 are somehow exerting an expanding force. Alternatively, there would also be no impediment, if it is of interest and depending on the specifications of the project, for these springs to also be mounted in an extended way and, therefore, performing the same tasks of balanced distribution of loads and efforts exerted by the spray arms.

Thus, as can be seen better in the representations of FIGS. 5A, 5B and 5C, the suspension assembly for spray boom, according to the present invention, presents a conventional operation, when the two spray arms 32, 34 are in the same position, extended and operative position, situation represented by FIG. 5A. The great difference of the present invention is more noticeable when the work vehicle 10 is performing tasks on the edge of the cultivated fields land, in which, normally, only one of the spraying arms 32, 34 is in the extended position and the other spraying arm 32, 34 is in the folded and inoperative position.

By way of example, as illustrates in FIG. 5B, the support frame 30 is displaced with respect to the support 36 in a clockwise rotation and thus the right side of the frame 30 moves downwards and the left side of the frame 30 is shifted upwards. In that case, the second spring 124 of the upper shock absorber sub-assembly 120 would be extended and the first spring 122 of the upper shock absorber sub-assembly 120 would be compressed. However, considering the new suspension assembly of the present invention the third spring 132 of the lower shock absorber sub-assembly 130 would also be extended and the fourth spring 134 of the lower shock absorber sub-assembly 130 would be compressed. Thus, as should be appreciated, under these conditions, the first spring 122 and the fourth spring 134 would be in a compressed condition exerting a force in opposite directions, while the second spring 124 and the third spring 132 would be in a relatively free condition and would not be exerting efforts on the support frame 30. Therefore, with this arrangement, it is noted that the efforts and loads 90 generated by the second spray arm 34 would be divided between the two sides of the support frame 30.

Analogously, and as illustrates in FIG. 5C, the support frame 30 is displaced with respect to the support 36, now in a counterclockwise rotation and thus, the left side of the frame 30 moves downwards and the right side of the frame 30 is shifted upwards. In that case, the first spring 122 of the upper shock absorber sub-assembly 120 would be extended and the second spring 124 of the upper shock absorber sub-assembly 120 would be compressed. With the new suspension assembly of the present invention the fourth spring 134 of the lower shock absorber sub-assembly 130 would also be extended and the third spring 132 of the lower shock absorber sub-assembly 130 would be compressed. Thus, as must be appreciated, under these conditions the second spring 124 and the third spring 132 would be in a compressed condition exerting a force in opposite directions, while the first spring 122 and the fourth spring 134 would be in a relatively free condition and would not be exerting efforts on the support structure 30. Therefore, with this arrangement, it is noted that the efforts and loads 90 generated by the first spray arm 32 would be divided between the two sides of the support frame 30.

In this context, as it will be appreciated by those skilled in the art, the arrangement of the lower shock absorber sub-assembly 130 is intended to provide a solution in which, in situation where the support structure 30 is displaced to one of the sides due to the efforts and loads generated by the spraying arm 32, 34, the springs that are compressed end up providing a balanced division of these loads on both sides of the support structure 30 and, thus, avoiding the problems caused by overloading on only one side.

In this sense, it is possible to say that the suspension assembly for the spray boom, object of the present invention, works in an “X” configuration, where the diagonally opposite springs present the same behavior and, with this, it becomes possible to obtain the effects and results of more evenly distributing the efforts and loads generated by the spray arms 32, 34, especially when only one of the arms is in the extended and operating condition.

Additionally, as can be seen, said shock absorbers 136, 138 positioned next to the third and fourth springs 132, 134 work helping the shock absorber work of said springs, so that the respective shock absorbers end up exercising the same condition as the spring that is next to them side, i.e., in the condition illustrated in FIG. 5B, shock absorber 136 is extended, as spring 132 is extended, and shock absorber 138 is retracted, such as spring 134 is compressed. FIG. 5C illustrates the shock absorber 138 in the extended condition, as the spring 134 is extended, and the shock absorber 136 is retracted, as the spring 132 is compressed.

Also as mentioned above, the present invention also deals with a work vehicle, such as agricultural equipment of the sprayer type and/or applicator of agricultural substances in the field, which the vehicle comprises a chassis 12 supported by front and rear wheels 14, 16, or optionally tracks assemblies, said chassis accommodates an engine and has an operator's cabin 20 within which various control devices are arranged to allow an operator to monitor and control the operation of a work vehicle 10 at the same time along the field, furthermore, the chassis 12 can support a tank 26 which is generally configured to store or hold an agricultural substance such as a pesticide, fungicide, rodenticide, fertilizer, nutrient and/or similar products, whereby the work vehicle also comprises a spray boom mounted next to the chassis 12 through a support 36 and a support frame 30 comprising a suspension assembly as mentioned above.

Accordingly to a particular embodiment of the present invention, said agricultural vehicle is a self-propelled sprayer intended for the distribution of agricultural substances in the field.

Finally, it is worth noting that the present description only aims to present and define, in an exemplary way, particular and possible embodiments of the suspension assembly for the spray boom, applied to work vehicles according to the present invention. Therefore, as a person skilled in the art should appreciate, several modifications and combinations of elements and equivalent details are possible without, therefore, deviating from the scope of protection defined by the attached claims.

1. A suspension assembly for a spray boom of an agricultural equipment, comprising an upper shock absorber sub-assembly formed by a first spring and a second spring that connect a support frame and a support, respectively in their side portions, wherein the suspension assembly comprises a lower shock absorber sub-assembly formed by a third spring and a fourth spring connecting lower portions of the support frame and the support.

2. The suspension assembly according to claim 1, wherein the third and fourth springs are mounted in a side-central configuration, such that one end of the third spring and one end of the fourth spring are anchored in a lower side region of the support, and the other end of the third spring and the other end of the fourth spring are anchored in a lower central region of the support frame.

3. The suspension assembly according to claim 1, wherein the first spring of the upper shock absorber sub-assembly is aligned with the third spring of the lower shock absorber sub-assembly.

4. The suspension assembly according to claim 1, wherein the second spring of the upper shock absorber sub-assembly is aligned with the fourth spring of the lower shock absorber sub-assembly.

5. The suspension assembly according to claim 1, wherein the first, second, third, and fourth springs of the upper and lower shock absorber sub-assemblies comprise the same spring constant K.

6. The suspension assembly according to claim 1, wherein the first, second, third, and fourth springs of the upper and lower shock absorber subassemblies comprise different spring constants K.

7. The suspension assembly according to claim 1, wherein the lower shock absorber sub-assembly comprises shock absorbers positioned beside the third and fourth springs.

8. The suspension assembly according to claim 1, wherein the first, second, third, and fourth springs are mounted on the suspension assembly in a compressed condition.

9. An agricultural work vehicle, comprising a chassis supported by front and rear wheels, or track assemblies, in which the chassis accommodates an engine and has an operator cabin inside which control devices are arranged, wherein the chassis supports a tank configured to store agricultural substances, the agricultural work vehicle comprises the spray boom mounted next to the chassis through the support and the support frame, and the agricultural work vehicle comprises the suspension assembly of claim 1.

10. The agricultural work vehicle according to claim 9, wherein the agricultural equipment comprises a sprayer or applicator of the agricultural substances in a field.
